(19) United States
(12) Patent Application Publication
(10) Pub. No.: US 2003/0175406 A1
(43) Pub. Date: Sep. 18, 2003

(54) Honey-butter

(76) Inventor: Manfred Villing, Winnipeg (CA)

Correspondence Address: SHAPIRO COHEN, P.O. BOX 3440, STATION D, OTTAWA, ON, K1P6P1, CA

(21) Appl. No.: 10/384,713

(22) Filed: Mar. 11, 2003

(30) Foreign Application Priority Data
Mar. 14, 2002 (CA) 2,376,708

(51) Int. Cl. A23G 3/00

(52) U.S. Cl. 426/658

(57) ABSTRACT

Clarified butter ghee is prepared by heating and filtering of butter. The ghee is added to a mixture of water stabilizer and dextrose then heated. Liquid and creamed honey are added to the mixture and blended in a mixer.

### FIELD OF INVENTION

The present invention relates to novel butter products and to a process of producing the same.

### BACKGROUND OF INVENTION

There is considerable demand for butter products possessing a honey flavour that are spreadable at room as well as at refrigeration and even freezer temperatures. The value and tastiness of honey have been recognized for centuries, but the physical properties of natural honey, particularly its viscosity, have presented difficulties in combining it with products such as butter.

Conventional processes for the manufacture of honey butter blends have combined honey and butters of varying fat contents, but these blends have been invariably complex, and the resultant butter products were either inconsistent in texture, off in flavour and/or have had short shelf lives, as well as weeping or oiling-out.

Conventional honey-butter making processes also employ dairy cream (sweet cream or whey cream), the use of which adversely affect the shelf-life of the honey-butter product. For example, U.S. Pat. No. 5,468,513 issued to Facrell, R. N. et. al. employs dairy cream or another milk fat source in its process, which must, of necessity employ preservative(s) to increase the shelf-life or storage time of the product. One advantage of the invention disclosed herein is that it does not employ dairy cream of any sort, but uses clarified butter (known as ghee in India), which is butter with all of the water and residual milk solids removed. The shelf-life is thus longer than conventional honey-butter products which do not utilize ghee, and the resultant product can even be stored without refrigeration.

Yet another advantage of the novel clarified butter-honey blend is that it is essentially free of weeping and oiling out. Furthermore, the process by which the products are made has the advantage that it does not require or use ultrafiltration as does the process of butter product-making disclosed in U.S. Pat. No. 4,769,255 issued Sep. 6, 1988 to Ahmed et. al. Ultrafiltration equipment requires significant financial investment and generates waste product which results in disposal problems in that it cannot be discharged into the sewer system.

### SUMMARY OF THE INVENTION

Disclosed herein is a novel, reduced moisture content honey-butter combined in a solid form, and a novel process for manufacturing this product at acceptable cost and without the generation of harsh chemicals or polluting effluents.

Specifically, an object of the present invention is to produce a homogeneous compound of honey and butter possessing the physical properties of solidness and the smooth texture of butter for ease of handling, storage, and packaging without the attendant inconvenience of handling and employing honey.

We have discovered that butter in the clarified state (ghee) can be emulsified with honey to produce a product of approximately the same physical properties as butter, which product will retain the natural flavour of a mixture of butter and honey.

This invention, in conjunction with various objects and advantages thereof will be readily understood from a description of a preferred form of product embodying the invention and from a preferred process of producing the product. We, therefore, will describe in considerable detail one example of a process and product embodying the present invention.

The product of the present invention consists preferably of but six (6) ingredients: liquid honey; creamed honey; sugar (corn sugar or dextrose); ghee; water and a stabilizer (a gelatin). The term “honey” is used in the sense of encompassing any material of the properties of natural bees' honey whether the natural material is used or one artificially produced to simulate the properties of natural honey, for example sugar syrups. Similarly, the term “butter” is used to include butter substitutes, such as oleo, oleomargarine, butter oils and like substances that can be utilized to produce a clarified product. The colloidal or emulsifying material (the stabilizer) may be any of a number of substances provided that it is suitable for human consumption as food. Some examples are gelatin, pectin, egg albumen, agar, gum arabic and gum tragacanth.

The preferable proportions of the materials are critical to the physical and flavour properties of the product. Solid butter is heated on a stove or similar heating implement until the butter is melted. The stove temperature is then increased until the temperature reaches approximately 80 degrees Celsius. At this point the butter is filtered using a cheese cloth to produce clarified butter or ghee. The ghee is tempered to a temperature between 25 to 27 degrees Celsius. In a separate pot, water, corn sugar and gelatin are mixed, then the tempered ghee is added to the mixture and the stove set to level 3 to produce a mixture that is at or about 66 degrees Celsius. Liquid and creamed honey is then blended in a Hobart mixer to which is added the mixture of water, corn sugar and gelatin.

The product produced approximates the consistency of ordinary commercial butter, and it, additionally possesses all of the taste and flavour of ordinary honey and butter and may be used for the same purposes.

The following examples describe in detail the honey butters made in accordance with the principles of the present invention.

The following formula of the honey butter appears in Example 1 below.

TABLE 1

| Ingredient | Amount (g) | % Formulation |
|---|---|---|
| Honey (liquid) | 100.00 | 27.4 |
| Honey (creamed | 100.00 | 27.4 |
| Corn Sugar (Dextrose) | 50.0 | 13.6 |
| Ghee | 62.5 | 17.1 |
| Water | 50.0 | 13.7 |
| Stabilizer | 3.0 | 0.8 |
| TOTAL | 365.5 | 100.00 |

### EXAMPLE 1

1) Heat the butter on the stove at level 3 until all the solid butter has melted.

2) Increase the heat to level 6 until the temperature reaches approximately 80 degrees Celsius.

3) Filter the ghee from the melted butter using a cheese cloth.

4) Temper the ghee to 25-27 degrees.

5) Mix the water, dextrose and gelatin in a pot.

6) Add the tempered ghee to the water, dextrose and gelatin mix and heat on the stove at level 3 to 66 degrees.

7) Place the liquid and creamed honey in the Hobart mixer and add the heated mixture.

8) Blend the mixture at Speed 1 for 4.5 minutes (stop midway and manually scrape the bottom of the mixter).

9) Blend the mixture at Speed 2 for 30 seconds.

TABLE II
Honey Butter Formulation
(May 26/00-#1 formulation)—prepared May 26^{th} and May 29^{th}

| Ingredient | Amount (g) | & Formulation |
|---|---|---|
| Honey (liquid) | 100.0 | 27.4 |
| Honey (creamed) | 100.0 | 27.4 |
| Corn Sugar (dextrose) | 50.0 | 13.6 |
| Ghee | 62.5 | 17.1 |
| Water | 49.95 | 13.7 |
| Gelatin | 3.0 | 0.8 |
| Flavour* | 0.5 | .8 |
| TOTAL | 365.5 | 100.0 |

### EXAMPLE II

1) Heat the butter on the stove at level 3 until all the solid butter has melted.

2) Increase the heat to level 6 until the temperature reaches approximately 80 degrees.

3) Filter the ghee from the melted butter using a cheese cloth.

4) Temper the ghee to 25-27 degrees.

5) Mix the water, dextrose flavour and gelatin in a pot.

6) Add the tempered ghee to the water, dextrose and gelatin mix and heat on the stove at level 3 to 66 degrees.

7) Place the liquid and creamed honey in the Hobart mixer and add the heated mixture.

8) Blend the mixture at Speed 1 for 4.5 minutes (stop midway and manually scrape the bottom of the mixer).

9) Blend the mixture at Speed 2 for 30 seconds.

* Flavour is preferably Allura Red #40 Strawberry.

While the form of the invention herein described is well adapted for carrying out the objects of the present invention, it should be understood that various modifications and changes may be made without departing from the invention as embodied in the appended claims.

What is claimed:

1. A method of making honey butter which comprises the steps of mixing water with dextrose and a stabilizer, to which tempered ghee is added to provide a mixture which is then heated to 60 to 70 degrees Celsius, adding liquid and creamed honey and blending the mixture in a mixer at low speed for 4 to 5 minutes.

2. A method as defined in claim 1 of making honey butter comprising the steps of heating butter to 80 degrees Celsius, filtering clarified butter (or ghee) from the melted butter and cooling or tempering the ghee to 25 to 27 degrees Celsius.

3. A method as defined in claim 1 wherein the stabilizer is gelatin.

4. A method as claimed in claim 1 wherein flavouring is added to the mixture.

5. A honey butter comprising a blend of ghee honey and a stabilizer.

6. A honey butter comprising a mixture of the following ingredients in about the stated amounts:

| Ingredient | % Formulation |
|---|---|
| Honey (liquid) | 27.4 |
| Honey (creamed | 27.4 |
| Corn Sugar (Dextrose) | 13.6 |
| Ghee | 17.1 |
| Water | 13.7 |
| Stabilizer | 0.8 |
| TOTAL | 100.00 |

7. A honey butter comprising a mixture of the following ingredients in about the stated amounts:

| Ingredient | & Formulation |
|---|---|
| Honey (liquid) | 27.4 |
| Honey (creamed) | 27.4 |
| Corn Sugar (dextrose) | 13.6 |
| Ghee | 17.1 |
| Water | 13.7 |
| Gelatin | 0.8 |
| Flavour* | .8 |
| TOTAL | 100.0 |
